(19) United States
(12) Patent Application Publication
(10) Pub. No.: US 2025/0338046 A1
(43) Pub. Date: Oct. 30, 2025

(54) OPTIMIZING SWITCHING TIME IN OPTICAL TRANSPORT NETWORKS

(71) Applicants: Rakuten Mobile, Inc., Tokyo (JP); Rakuten Symphony India Private Limited, Indore (IN)

(72) Inventors: Ayajahamad BANKAPUR, Karnataka (IN); Ashish Ramesh GooJar, Tokyo (JP); Praveen Kumar, Tokyo (JP)

(73) Assignees: Rakuten Mobile, Inc., Tokyo (JP); Rakuten Symphony India Private Limited, Indore (IN)

(21) Appl. No.: 18/756,049

(22) Filed: Jun. 27, 2024

(30) Foreign Application Priority Data
Apr. 30, 2024 (IN) 202441034204

(51) Int. Cl. H04Q 11/00

(52) U.S. Cl. CPC H04Q 11/0062; H04Q 11/0005; H04Q 2011/0041; H04Q 2011/005; H04Q 2011/0081

(57) ABSTRACT

A method, apparatus, and system or implementing an optimization of switching time between fiber paths in a OTN, the method may include: receiving a client signal from a transmitter network; converting the client signal into a GFP formatted signal; duplicating the GFP formatted signal to a redundant GFP formatted signal; adding a GFP Order Identifier (GOI) to the converted client signal for a first path and a GFP Order Identifier (GOI) to the duplicated client signal for a second fiber path; sending the GFP formatted signal via the first fiber path; sending, the duplicated GFP formatted signal via the second fiber path; receiving the GFP formatted signal comprising the GOI; evaluating the GOI of the at least one received GFP formatted signal; determining that the GFP formatted signal is a duplicate of a previously received GFP formatted signal; and discarding, the duplicated GFP formatted signal.

### CROSS-REFERENCE TO RELATED APPLICATIONS

The present application claims priority to Indian Patent Application number 202441034204, filed on Apr. 30, 2024 in the Indian Patent Office, the entire disclosure of which is hereby incorporated by reference.

### FIELD

The president disclosure relates to optimizing switching time between fiber paths in optical transport networks.

### BACKGROUND

The information disclosed in this background section is only for enhancement of understanding of the general background of the disclosure and should not be taken as an acknowledgement or any form of suggestion that this information forms the prior art already known to a person skilled in the art.

In the related art, an optical transport network (OTN) is a type of high-capacity, high-speed network that may be used to transport large volumes of data over long distances via fiber paths. To this end, OTN's are designed to provide efficient and reliable transport of various types of data, including voice, video, and data traffic from transmitter networks to receiver networks (e.g., random access networks (RAN)).

Fiber cuts or signal degradation due to erroneous fiber paths are a common problem in OTN's that can occur due to various reasons such as natural disasters, human errors, equipment failures, etc. When a fiber cut or loss of signal in a fiber path occurs, it may result in significant disruptions to network services and communication.

Related art OTN networks may mitigate the impact of fiber cuts using various protection mechanisms (i.e., protection switching) such as automatically switching the traffic to a backup path in case of a fiber cut or other network failure. In the related art, the automatic switching of traffic may be reactively triggered by detecting a signal loss in a fiber path. In this case, the automatic switch may use a pre-defined protection path configured during network setup and activated when a fiber cut (i.e., a signal loss in a fiber path) is detected. Alternatively, a manual switch requires human intervention to redirect traffic to the backup path.

According to the related art, automatic switching of fiber paths can be initiated within 60 milliseconds (i.e., approximately up to 10 ms for reactive signal loss detection and 50 ms to switch traffic from a failed fiber path to a backup fiber path within 50 ms to ensure efficient and reliable transport of data).

To this end, in accordance with the relevant art, the 50 ms switching time is based on the ITU-T G.808.1 (Generic protection switching) recommendation, which specifies the requirements for OTN protection switching.

### SUMMARY

Related art OTN's struggle which use ultra-low latency communication networks

(i.e., ultra-low latency client networks) struggle with handling fiber cuts because ultra-low latency networks may require extremely fast data transmission speeds and minimal processing delays that cannot tolerate 50 ms switching time. As a result, there is a need for a more advanced protection mechanism to improve network resiliency and reduce the impact of fiber cuts in timing faster than the 50 ms switching time to ensure reliable and efficient transport of data over OTN's.

According to embodiments, methods, apparatuses, and systems for optimizing switching time in optical transport networks may be provided for a duplicate of a GFP formatted client signal to be transported over a separate fiber path and a GFP Order Identifier (GOI) for identifying a GFP formatted client signal in a first fiber path and its duplicate in a second fiber path, wherein the GFP Order Identifier (GOI) allows a determination whether the duplicate of the GFP formatted client signal can be discarded. One of the results may be that if no duplicate is determined, the GFP formatted client signal was not received in the first fiber path (i.e., the signal was lost in the first fiber) and the duplicate in the second fiber path is seamlessly processed for transport to the receiving network. Accordingly, a proactive mechanism of providing a duplicate of the GFP formatted client signal to be transported over a separate fiber path may achieve seamless switching (transition) time between tens or hundreds of nanoseconds. In particular, the seamless switching (i.e., proactive protection mechanism) as set forth above may be much faster, and may meet the requirements of ultra-low latency client networks, thereby enabling the processing of next-generation time-critical services (e.g., (open) RAN-based Internet of Things (IoT) networks, autonomous driving, etc.).

According to embodiments, a method may be provided. The method may include: receiving, by a Generic Framing Procedure (GFP) mapper, a client signal from a transmitter network; converting, by the GFP mapper the client signal into a GFP formatted signal to be transported via a first fiber path; duplicating, by the GFP mapper, the GFP formatted signal to a redundant GFP formatted signal to be transported via a second fiber path; adding, by the GFP mapper, a GFP Order Identifier (GOI) to the converted client signal for the first path and a GFP Order Identifier (GOI) to the duplicated client signal for the second fiber path; sending, by a first line card, the GFP formatted signal via the first fiber path; and sending, by a second line card, the duplicated GFP formatted signal via the second fiber path.

According to embodiments, a system including a transmitter and a receiver may be provided, wherein the transmitter is configured to: receive a client signal from a transmitter network, convert the client signal into a GFP formatted signal to be transported via a first fiber path, duplicate the GFP formatted signal to a redundant GFP formatted signal to be transported via a second fiber path, add a GFP Order Identifier (GOI) to the converted client signal for the first path and a GFP Order Identifier (GOI) to the duplicated client signal for the second fiber path, send the GFP formatted signal via the first fiber path, and send the duplicated GFP formatted signal via the second fiber path to the receiver.

According to embodiments, at least one non-transitory computer-readable recording medium having recorded thereon instructions executable to implement a method may be provided, the method including: receiving, by a Generic Framing Procedure (GFP) mapper, a client signal from a transmitter network; converting, by the GFP mapper the client signal into a GFP formatted signal to be transported via a first fiber path; duplicating, by the GFP mapper, the GFP formatted signal to a redundant GFP formatted signal to be transported via a second fiber path; adding, by the GFP mapper, a GFP Order Identifier (GOI) to the converted client signal for the first path and a GFP Order Identifier (GOI) to the duplicated client signal for the second fiber path; sending, by a first line card, the GFP formatted signal via the first fiber path; and sending, by a second line card, the duplicated GFP formatted signal via the second fiber path.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1A illustrates a reactive protective switching in an optical transport network (OTN) according to the related art;

FIG. 1B illustrates a reactive protective switching in case of a fiber cut in an OTN according to the related art;

FIG. 2A illustrates a proactive protective mechanism in an OTN according to an embodiment;

FIG. 2B illustrates a proactive protective mechanism in case of a fiber cut in an OTN according to an embodiment;

FIG. 3 illustrates the addition of a GFP Order Identifier (GOI) to a GFP frame header to implement the proactive protective mechanism according to an embodiment;

FIG. 4 illustrates a method for sending GFP formatted client signal and a duplicate thereof in an OTN with a proactive protective mechanism according to an embodiment;

FIG. 5 illustrates a method for receiving at least one GFP formatted client signal in an OTN with a proactive protective mechanism according to an embodiment;

FIG. 6 illustrates a method for receiving at least one GFP formatted client signal in an OTN with a proactive protective mechanism according to an embodiment;

FIG. 7 illustrates a method for implementing an optimization of switching time between fiber paths in OTN's according to an embodiment;

FIG. 8 is a diagram of an example environment in which systems and/or methods, described herein, may be implemented; and

FIG. 9 is a diagram of example components of a device according to an embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

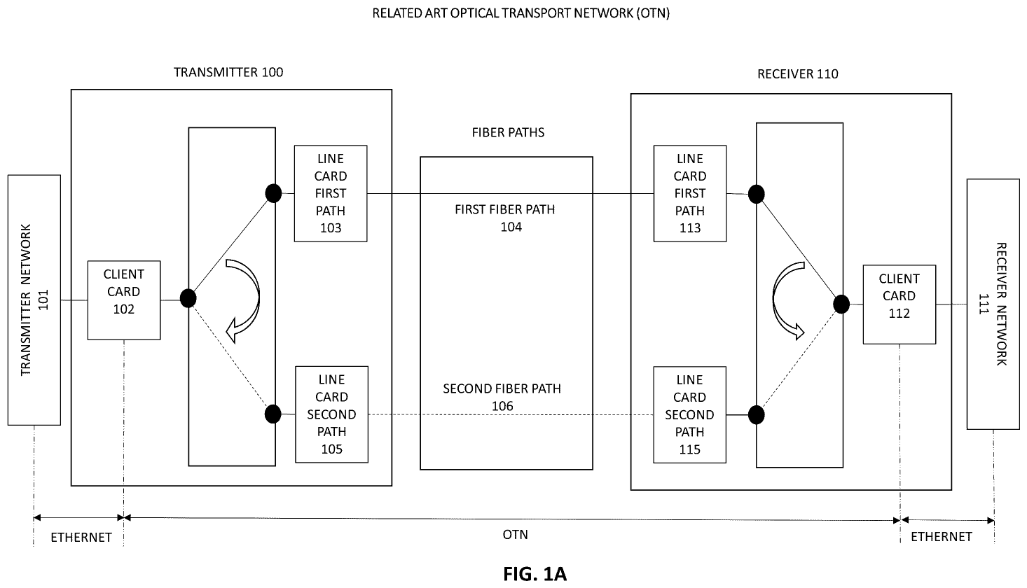

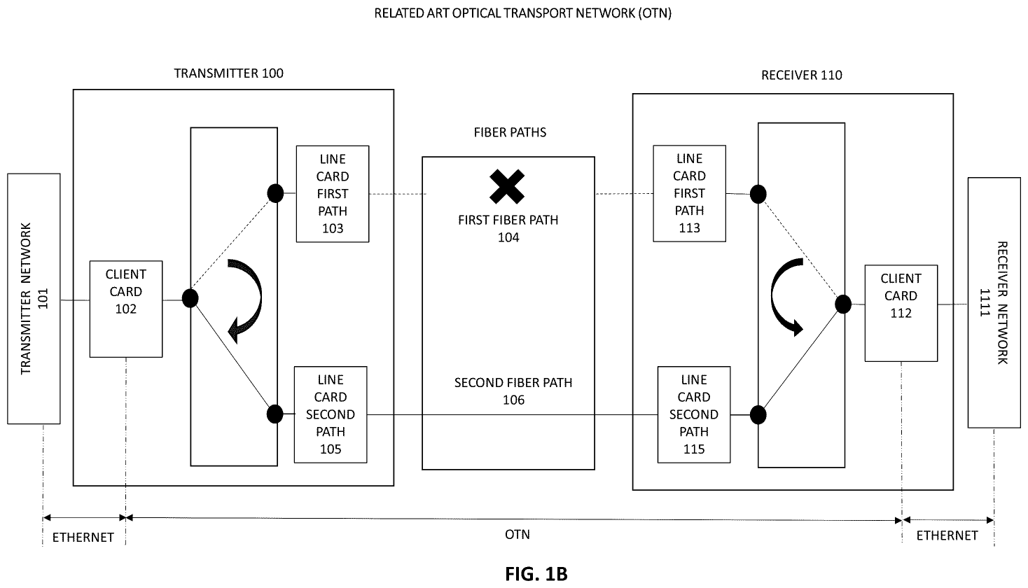

FIG. 1A illustrates a reactive protective switching in an optical transport network (OTN) according to the related art.

Referring to FIG. 1A, an Optical Transport Network (OTN) according to the related art refers to a high-speed communication network that uses optical fibers to transport signals from a transmitter network 101 to a receiver network 111. The OTN comprises of various components, including a transmitter 100 and a receiver 110.

Transmitter 100 in the related art may include at least one client card 102, at least one GFP mapper, one or more line cards 103, 105 and at least one switch between at least one client card 102 and one or more line cards 103, 105.

For example, client card 102 in the related art may be responsible for interfacing with client networks (e.g., a transmitter network 101). The client networks of a client card may vary depending on the type of User Entities (UE's) and the client devices (e.g., network elements such as routers, switches, servers, etc.) being used. For example, a client network may be a Local Area Network (LAN) (i.e., a client card can interface with the LAN using various Ethernet standards, such as 10G Ethernet, 40G Ethernet, or 100G Ethernet, etc.

Another example of a client network in the related art may be a Storage Area Network (SAN), which may be used to provide high-speed access to storage devices. The client card may interface with the SAN using various Fiber Channel standards, such as a 8G Fiber Channel or 16G Fiber Channel.

In addition to LAN's and SAN's, client networks according to the related art may also include WAN's (Wide Area Networks), which are used to connect geographically dispersed networks and network elements (e.g., the WAN may be part of a RAN, such as a backbone connection of networks elements in a RAN, a breakout connection between RANs of different operators, etc.). To this end, the client card may interface with the WAN using various protocols (e.g., SONET/SDH, MPLS, DWDM, etc.)

In general, client networks (i.e., transmitter networks, receiver networks) of a client card 102, 112 in an OTN according to the related art can be diverse and can vary depending on the specific requirements of the User Entity UEs being used. The client card 102, 112 must be able to support a wide range of network protocols and standards to ensure seamless communication between the UEs and the OTN.

Referring back to FIG. 1A, transmitter 100, client card 102 in the related art may receive a client signal from a transmitter network 101. For example, the client card 102 comprises a GFP (Generic Framing Procedure) mapper. The GFP mapper is responsible for mapping the client signals (e.g., Ethernet, SONET, and SDH, etc.) into an OTN frame structure (e.g., GFP frame structure format).

To the end, the GFP mapper in the related art may add a GFP header to the client signal, which includes information such as the client type, payload length, and error checking. The GFP mapper in the related art may also map the resulting GFP frame into the OTN frame structure, which may include additional overhead for error correction, performance monitoring, and network management.

The OTN frame in the related art may subsequently be transmitted via send via a switch (not pictured) to line card 103 or line card 105. The switch in the related art may connect multiple line cards and enables the switching of traffic between different fiber paths in the OTN. The switch in the related art may be responsible for directing traffic between the first (working) fiber path and the second (protective) fiber path, depending on the state of the network.

For example, client card 102 may send the OTN frame via the switch to line card 103 of the first fiber path. In this case, line card 105 of the second fiber path is inactive and does not receive an OTN frame from client card 102. To this end, the first (working) fiber path is the primary path that is used to transport data (i.e., the OTN frames) over the optical network and the second (protective) fiber path is a backup path that is used in case of a signal loss or fiber cut of the first (working) fiber path. When a signal loss or fiber cut occurs, the switch automatically switches the traffic from the working fiber path to the protective fiber path to ensure the continuity of OTN services.

In transmitter 100 in the related art, line cards 103 and 105 are responsible for interfacing the transmitter to the first and the second fiber path of OTN, respectively.

In general, line cards in the related art may comprise various optical components such as optical transmitters, receivers, and amplifiers. The transmitters may be responsible for converting electrical signals into optical signals that can be transmitted over the optical fiber path. The receivers in line cards, on the other hand, may be responsible for converting the optical signals back into electrical signals that can be processed by other network components.

Referring to FIG. 1A, first line card 103 in the related art may convert electrical signals (i.e., the OTN frame structure from a client card 102) into optical signals and sends it via the first fiber path (e.g., the working fiber path) to a receiver 110.

Receiver 110 in the related art may be responsible for receiving the optical signals from the fiber paths of the OTN and comprises multiple line cards 113, 115 as set forth above. The line cards 113, 115 in receiver 110 are responsible for converting the optical signals back into electrical signals that can be processed by the client card 112.

Receiver 110 may also comprises a switch that connects line cards 113, 115 with the client card 112 and enables the switching of traffic between different fiber paths in the OTN.

The switches in the transmitter 100 and receiver 110 may be in communication and may be jointly responsible for directing traffic between the first (working) fiber path and the second (protective) fiber path, depending on the state of the network.

Moreover, at the receiver 110, client card 112 in the related art may comprise a GFP de-mapper. The GFP de-mapper at the receiver end may be responsible for de-mapping the received OTN frames and converting them back into the client signals. The GFP de-mapper may also includes various decoding and error correction techniques to ensure the accuracy and reliability of the received signals.

As a result, in accordance with the related art, the client cards, the GFP mapper and de-mapper, the line cards, and the switches in the transmitter and receiver may work together to enable the OTN to switch between the first (working) fiber path and the second (protection) fiber path, wherein the second (protection) fiber path and all components that handle the transport of traffic over the second (protection) fiber path are inactive until a signal degradation (e.g., a signal loss or fiber cut) is detected in the first (working) fiber path.

This reactive mechanism in the related art has a disadvantage that detection and switching take time (e.g., up to 60 ms) which may be not tolerable for time-critical applications in ultra-low latency communication networks.

FIG. 1B illustrates a reactive protective switching in case of a fiber cut in an OTN according to the related art.

Referring to FIG. 1B, a fiber cut has occurred in the first fiber path in the OTN according to the related art. Upon detecting that there is a fiber cut in the first fiber path, the receiver 110 signals the transmitter 100 to switch traffic from the first (working) fiber path 104 (i.e., the primary fiber path that transported the traffic) to the inactive second (protective) fiber path 106 (i.e., the in-active backup fiber path) and to activate the respective components in the second fiber path 106 (i.e., line card 105 and line card 115 of the second fiber path 106).

While switching the client signal from the transmitter network 101 from the path between client card 102 and the line card 103 to the path between client card 102 and the line card 105 (i.e., from the line card 103 of the first fiber path 104 to the line card 105 of the second fiber path 106) at the transmitter side, receiver 110 switches from the first fiber path 104 to the second fiber path 106 to receive the OTN frames (i.e. optical signals) via line card 115 at the client card 112.

In the case where all components of the second fiber path 106 are active, the GFP de-mapper according to the related art extracts the client data frames from the GFP frames (i.e., OTN frame structure) received from the line card 115 and performs the reverse function of the GFP mapper to provide client signals to the receiver network 111.

As a result, the signaling activation to commence the switching may take 50 ms based on the standard recommendation according to the related art (e.g., ITU-T G.808.1 (Generic protection switching) recommendation), which is not acceptable for ensuring an error-free and resilient operation of an ultra-low latency communication network. In contrast, embodiments as described herein below may be adapted to ultra-low latency communication networks.

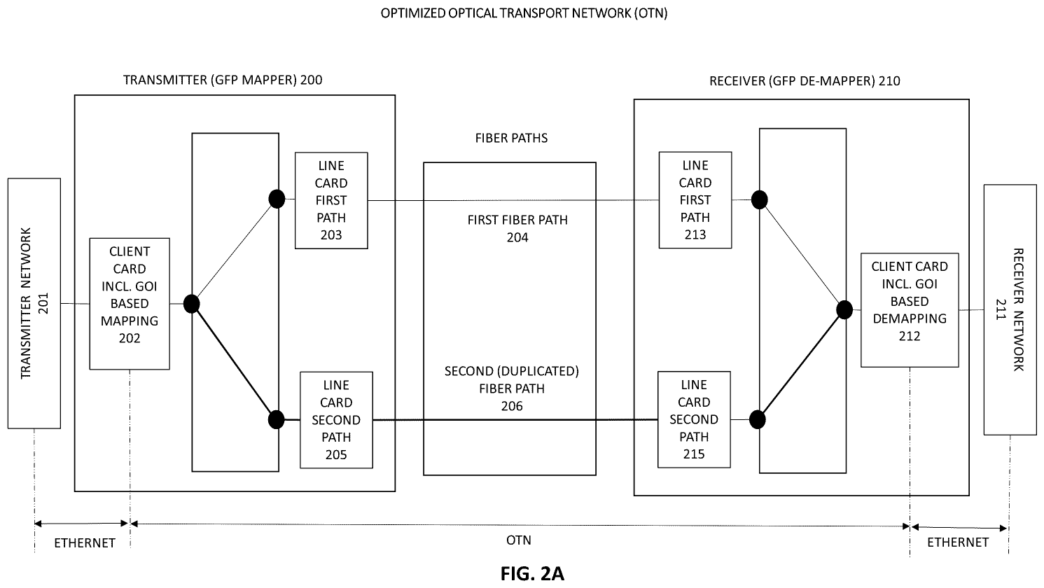

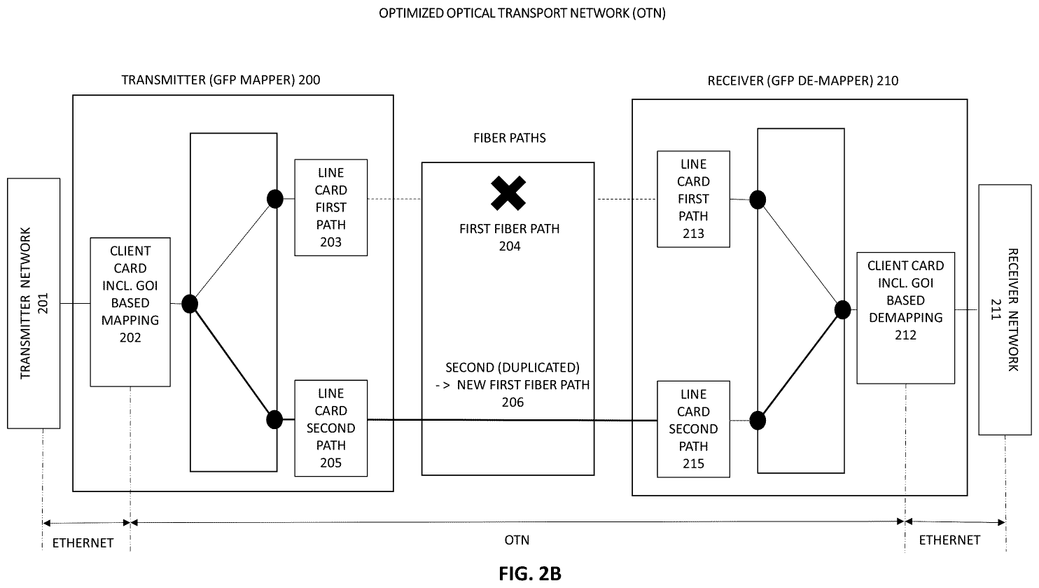

FIG. 2A illustrates a proactive protective mechanism in an OTN according to an example embodiment.

Referring to FIG. 2A, transmitter 200 receives a client signal from a transmitter network 201, according to an embodiment. For example, the client signal may be an Ethernet signal used for LAN connections (e.g., 10G, 40G, or 100G Ethernet standard, etc.) or, among others, a client signal of other network protocols such as Fiber Channel over Ethernet (FCoE), TCP/IP, etc.

In transmitter 200, the client signal may be received by client card 202. The client card 202 can support a wide range of network protocols and standards to ensure seamless communication between the transmitter network 201 and the OTN (e.g., capable of handling an ultra-low latency communication network, such as for operating an open RAN, an Internet of Things (IoT) communication network, etc.). Furthermore, client card 202 may include a Generic Framing Procedure (GFP) mapper. The GFP mapper may convert the client signal into a GFP-formatted signal to be transported via a first fiber path.

According to an embodiment, the GFP mapper may maps the client signals into an OTN frame structure (e.g., GFP frame structure format) and adds a GFP header to the client signal, which includes information such as the client type, payload length, and error checking.

Referring to FIG. 2A, client card 202 and/or the GFP mapper may duplicate the GFP formatted signal to a redundant GFP formatted signal to be transported via a second fiber path. For example, client card 202 and/or the GFP mapper replicate the converted GFP formatted signal to be transported via a first fiber path near real-time.

Upon duplicating the GFP formatted signal to a redundant GFP formatted signal, the GFP mapper adds a GFP Order Identifier (GOI) to the converted client signal for the first path 204 and a GFP Order Identifier (GOI) to the duplicated client signal for the second fiber path 206.

According to embodiments, the GOI may be implemented as at least one bit in a GFP frame header field. For example, the GOI may be implemented in one of the reserved fields of a GFP core header field and/or in a payload header field.

The GFP mapper may map the resulting GFP frame of each GFP formatted signal into its OTN frame structure.

Upon mapping the client signal and redundant duplicate of the client signal into its respective OTN frame structure, the client card 202 may send the GFP formatted signal to a first line card 203 of the first path 204 and the redundant duplicate thereof to the second line card 205 of the second path 206.

Referring to FIG. 2A, first line card 203 and the second line card 205 are illustrated as being active. The first line card 203 may convert electrical signals (i.e., the GFP formatted signal from the client card 202) into an optical signal and sends the optical signal via the first fiber path (e.g., the working fiber path) to line card 213 of the receiver 210.

Second line card 205 may convert electrical signals (i.e., the duplicated GFP formatted signal from the client card 202) into an optical signal and sends the optical signal via the second fiber path (e.g., the protective fiber path) to line card 215 of the receiver 210.

At receiver 210, at least one line card 213 and/or 215 receives the optical signal from transmitter 200. In the case there is no fiber cut in the first fiber path 204, line card 213 receives the optical signal including the GFP formatted signal (which includes the GOI as added by the GFP mapper in transmitter 200). According to embodiments, the GOI may identify the GFP formatted signal and enable the GFP de-mapper to evaluate and determine when a GFP formatted signal was received, and whether the GFP formatted signal has a duplicate (or not).

In the case there is no fiber cut in the second fiber path 206, line card 215 may receive the optical signal comprising a redundant duplicate of the GFP formatted signal (which includes the GOI as added by the GFP mapper in the transmitter 200).

According to some embodiments, there may be latency effects between the first fiber path 204 and the second fiber path 206. As a result, there may be OTN conditions resulting from the latency effects (e.g., when line card 215 receives the optical signal via the second fiber path 206 before line card 213 receives the optical signal via the first fiber path 204).

According to embodiments, line card 213 and line card 215 may convert the optical signal back to an electrical signal and forward the respective signals to client card 212. According to embodiments, client card 212 may include the GFP de-mapper.

As an example, at client card 212, the GFP de-mapper may extract the client data frames from the GFP frames (i.e., including the GOIs) received from line card 213 and/or line card 215. According to embodiments, the GFP de-mapper may perform the reverse function of the GFP mapper to provide client signals to the receiver network 211.

Still referring to FIG. 2A, the GFP de-mapper may evaluate the GOI of at least one received GFP formatted signal from first line card 213 and/or second line card 215.

For example, the GFP de-mapper evaluates the GOIs of the signals received from first line card 213 and/or second line card 215.

Based on the evaluation of the GOIs of one or more signals received from first line card 213 and/or second line card 215, the GFP de-mapper may determine that the GFP formatted signal (e.g., the signal received by the second line card 215) is a redundant duplicate of a previously received GFP formatted signal (e.g., the signal received by the first line card 213).

According to another example, the GFP de-mapper may evaluate the GOIs of the signals received from the first line card 213 and the second line card 215, wherein the client card 212 receives the signal of the second line card 215 before the signal of the first line card 213. In this example case, based on the evaluation of the GOIs of both signals, the GFP de-mapper may determine that the GFP formatted signal (e.g., the signal received by the first line card 213) is a redundant duplicate of a previously received GFP formatted signal (e.g., the signal received by the second line card 215).

According to embodiments, upon determining that a GFP formatted signal is a redundant duplicate of a previously received GFP formatted signal, the GFP de-mapper (i.e., client card 212) may discard the duplicated GFP formatted signal. In this case, client card 212 may convert the GFP formatted to the client signal format of a receiver network 211, and send the converted client signal to the receiver network 211.

FIG. 2B illustrates a proactive protective mechanism in case of a fiber cut in an OTN according to an embodiment.

Referring to FIG. 2B, a fiber cut occurred in the first fiber path 204. In this case, the signal over the first fiber path 204 is lost, and only the second line card 215 receives the optical signal over the second fiber path 206 (i.e., the redundant duplicate of the GFP formatted signal including the GOI as added by the GFP mapper in the transmitter 200). Accordingly, line card 215 may the optical signal back to an electrical signal and transmits it to client card 212.

At client card 212, the GFP de-mapper may extract the client data frames from the GFP frames (i.e., GFP formatted signal including a GOI) received from line card 215 and perform the reverse function of the GFP mapper to provide client signals to the receiver network 211. According to embodiments, the GFP de-mapper may evaluate the GOI's of the received signals of the first line card 213 and the second line card 215.

According to embodiments, when a fiber cut occurs (as described above) while evaluating the GOI of at least one received GFP formatted signal (i.e., the signal of the second line card 215), the GFP de-mapper may determine, based on the evaluation of the at least one GOI, that the GFP formatted signal received via the second fiber path 206 is not a redundant duplicate of a previously received GFP formatted signal. Accordingly, the GFP de-mapper may determine (e.g., based on the GOI of only one signal) that the GFP formatted signal (e.g., the signal received by the second line card 215) is not a redundant duplicate of a previously received GFP formatted signal (i.e., a signal from the first line card 213 was never received).

According to another embodiment, a fiber cut may have occurred in the second fiber path 206. In this case, the GFP de-mapper may evaluate that the received GFP formatted signal only includes GOIs of signals received from the first line card 213. Accordingly, based on the signals received by the first line card 213, the GFP de-mapper may determine that the GFP formatted signal (e.g., the signal received by the first line card 213) is supported by redundant duplicate signals (e.g., a redundant duplicate of a previously received GFP formatted signal as set forth in FIG. 2A).

Regardless of whether a fiber cut occurred in the first fiber path 204 or a fiber cut in the second fiber path 206, based on the above described embodiments, upon determining that there is no redundant duplicate of a previously received GFP formatted signal (i.e., the received GFP formatted signal is not a redundant duplicate of a previously received GFP formatted signal), the GFP de-mapper (i.e., client card 212) may convert the received GFP formatted signal to a client signal format of a receiver network 211 and send the converted client signal to the receiver network 211.

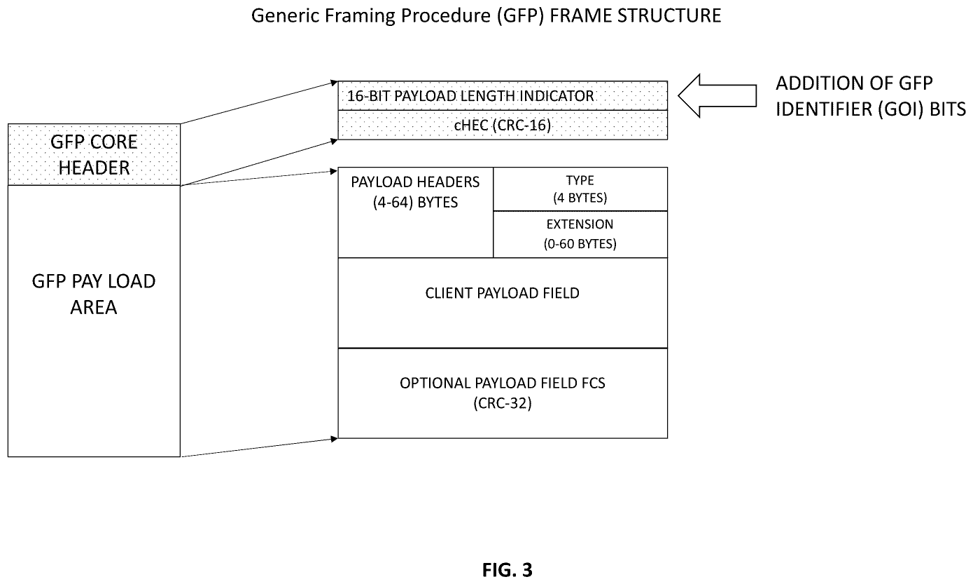

FIG. 3 illustrates the addition of a GFP Order Identifier (GOI) to a GFP frame header to implement the proactive protective mechanism according to an embodiment.

Referring to FIG. 3, the GFP frame structure may include a GFP core header and a GFP payload area. According to embodiments, the GFP core header may include a 16-bit payload length indicator and an error check functionality (i.e., Compact Header Error Control (CHEC) based on a 16-bit cyclic redundancy check (CRC-16)).

The GFP payload area may include (4-64)-byte payload headers, a client payload field, and an optional payload field including a Frame Check Sequence (FCS) based on a 32-bit cyclic redundancy check (CRC-32). The (4-64)-byte payload headers may include a 4-byte type header and an up to 60-byte header extension.

Regarding the proactive protective mechanism implemented on OTN's of the present disclosure (e.g., OTN illustrated in FIGS. 2A and 2B), the GFP mapper may add a GFP Order Identifier (GOI) to the signal for the first path 204 and a GFP Order Identifier (GOI) to the duplicated signal for the second fiber path 206. The GOI may be implemented as at least one bit in a GFP frame header field (e.g., implemented in a reserve field of a GFP frame header structure of the core header or the (4-64)-byte payload headers as set forth above.

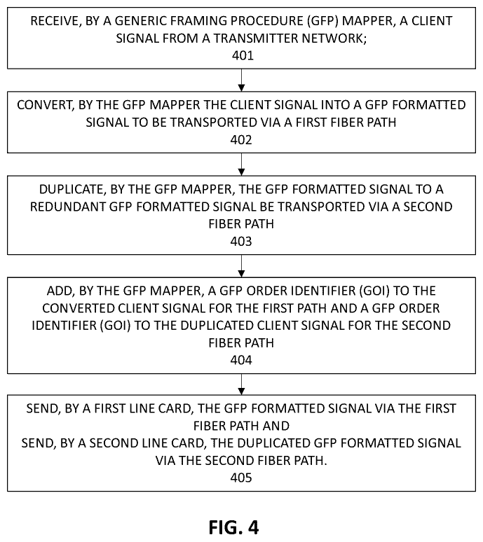

FIG. 4 illustrates a method for sending GFP formatted client signal and a duplicate thereof in an OTN with a proactive protective mechanism according to an embodiment. According to embodiments, the method illustrated in FIG. 4 may be implemented by a transmitter.

Referring to FIG. 4, in step 401, a transmitter (i.e., a transmitter 200 of FIGS. 2A and 2B) for implementing an optimization of switching time between fiber paths in optical transport networks (OTN) may include a Generic Framing Procedure (GFP) mapper, wherein the GFP mapper receives a client signal from a transmitter network.

In step 402, the GFP mapper converts the client signal into a GFP formatted signal to be transported via a first fiber path. For example, the GFP mapper may convert the client signal of a client network to a GFP formatted signal, wherein GFP mapping is a process used in optical transport networks to encapsulate client data frames into GFP frames for transport over the OTN (i.e., GFP mapping enables the transport of a wide range of client protocols over OTN's, including Ethernet, SONET/SDH, Fiber Channel, etc.). The GFP frame structure for transport over the OTN may be similar to the GFP frame structure as illustrated in FIG. 3.

In step 403, the GFP mapper may duplicate the GFP formatted signal to a redundant GFP formatted signal to be transported via a second fiber path. For example, the GFP mapper may reproduce the GFP formatted signal to be transported via a first fiber path as a part of the proactive mechanism (such as those illustrated in FIGS. 2A and 2B).

In step 404, the GFP mapper may add a GFP Order Identifier (GOI) to the converted client signal for the first path and a GFP Order Identifier (GOI) to the duplicated client signal for the second fiber path. For example, with reference to FIG. 3 as described above, a GOI may be implemented as at least one bit in a GFP frame header field (e.g., implemented in a reserved field of a GFP frame header structure of the core header or the (4-64)-byte payload headers).

In step 405, a first line card (of the transmitter) may send the GFP formatted signal via the first fiber path and a second line card (of the transmitter) may send the duplicated GFP formatted signal via the second fiber path.

As a result, the method for sending GFP formatted client signal and a duplicate thereof in an OTN with a proactive protective mechanism according to the example embodiment illustrated in FIG. 4 may allow the OTN to support proactive redundancy by introducing a GOI to identify a client signal and its duplicate in respective GFP frame headers, and by permanently sending via a second fiber path over the OTN. One of the advantages of this feature may be that in the event of a fiber cut, no re-active switching and activation of secondary line cards may be required. The transmitter according to example embodiments may allow the OTN to seamlessly transit between redundant signals between a first fiber path and a second fiber path without notice of higher layer services (e.g., a transit time between tens to hundreds of nanoseconds).

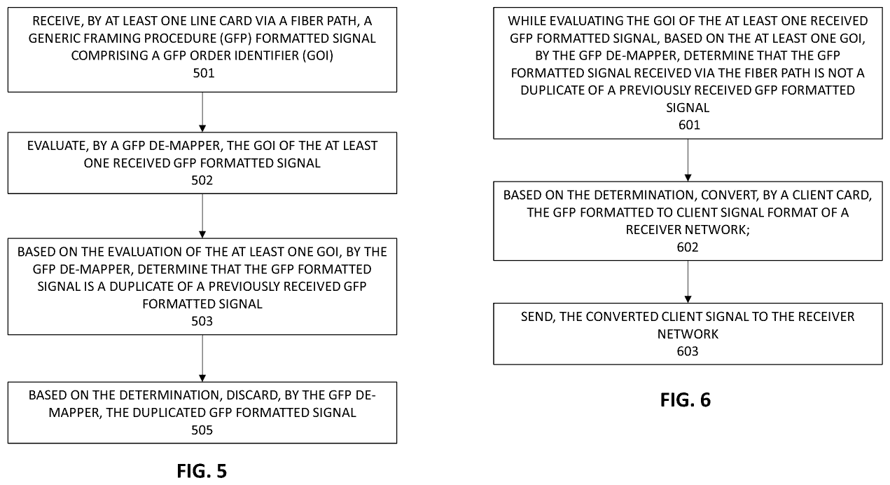

FIG. 5 illustrates a method for receiving at least one GFP formatted client signal in an OTN with a proactive protective mechanism according to an embodiment. According to embodiments, the method illustrated in FIG. 5 may be implemented by a receiver.

Referring to FIG. 5, in step 501, a receiver for implementing an optimization of switching time between fiber paths in optical transport networks (OTN) may include at least one line card, a GFP de-mapper and a client card, wherein the at least one line card, via a fiber path, receives a Generic Framing Procedure (GFP) formatted signal comprising a GFP Order Identifier (GOI).

In step 502, the GFP de-mapper may evaluate the GOI of at least one received GFP formatted signal. For example, depending on which fiber path of a first fiber path or a second fiber path the GFP formatted signal was firstly received, the GFP de-mapper evaluates the GOI of received GFP formatted as being a firstly (previously) or secondly (redundantly) GFP formatted signal.

In step 503, based on the evaluation of at least one GOI, the GFP mapper may determine that the GFP formatted signal is a duplicate of a previously received GFP formatted signal. For example, depending on which fiber path (e.g., a first fiber path or a second fiber path) the GFP formatted signal was first received, the GFP de-mapper may determine, based on evaluation of at least one GOI whether the GFP formatted signal of the first fiber path or the second fiber path is a duplicate of a previously received GFP formatted signal.

In step 505, based on the determination the GFP de-mapper may discard the duplicated GFP formatted signal. For example, either the GFP formatted signal of the first fiber path or the GFP formatted signal of the second fiber path may be a duplicate of a previously received GFP formatted signal of the other fiber path, depending on the latency constraints of the first fiber path and the second fiber path and the OTN state at the time the GFP formatted signals of the first fiber path and the second fiber path are received.

Based on the above-described example with reference to FIG. 5 for receiving at least one GFP formatted client signal in an OTN with a proactive protection mechanism, an OTN receiver may be allowed to permanently receive and process at least one GFP formatted signal of the first fiber path or the second fiber path regardless of whether it was received via a first (working) fiber path that primarily transports traffic over the OTN or via a second (protection) fiber path that proactively supports seamless transit between redundant signals between the first fiber path and the second fiber path.

Accordingly, example embodiments described with reference to FIG. 5 may have at least one advantage of introducing permanent evaluation and determination steps, such that if a predefined (constant) ultra-low latency is introduced, the predefined latency will not change in the event of a fiber cut (i.e., independent of a fiber cut, the receiver may constantly determine whether the GFP formatted signal is a duplicate of a previously received GFP formatted signal or not), thereby facilitating failover latency prediction for efficient and resilient operation of ultra-high latency communication networks.

FIG. 6 illustrates a method for receiving at least one GFP formatted client signal in an OTN with a proactive protective mechanism according to an embodiment. According to embodiments, FIG. 6 may be implemented by a receiver.

Referring to FIG. 6, while evaluating the GOI of the at least one received GFP formatted signal, in step 601, based on the evaluation of the at least one GOI (e.g., whether both signals from the first fiber path and the second fiber path were received and/or only one signal of the first fiber path or the second fiber path was received), the GFP de-mapper may determine that the GFP formatted signal received via the fiber path is not a duplicate of a previously received GFP formatted signal.

According to an example embodiment, in the event the receiver only receives one signal (e.g., from the first fiber path when a fiber cut may have occurred in the second fiber path), the GFP de-mapper, based on the evaluation of the GOI of the GFP formatted signal of the first fiber path, may determine that the GFP formatted signal received via the fiber path (e.g., the first fiber path) is not a duplicate of a previously received GFP formatted signal (i.e., there is no other previously received GFP formatted signal and no duplicate of a previously received GFP formatted signal as indicated by the GOI evaluation).

In step 602, based on the determination in step 601, a client card (i.e., the receiver) converts the GFP formatted signal to the client signal format of a receiver network. For example, the GFP mapper in the client card extracts the original client data frames encapsulated in the GFP frames that have been received from the line card.

In step 603, the client card may send the converted client signal to the receiver network.

Accordingly, the example method for receiving at least one GFP formatted client signal in an OTN with a proactive protective mechanism as illustrated in FIG. 6 may allow the receiver according to example embodiments to seamlessly transit from one signal in a (working) fiber path to another (duplicated) signal in a redundant fiber path case and verse visa. One of the advantages of the example method/receiver design described above is that if the receiver only receives one signal over the fiber path (i.e., a fiber cut has occurred), the method/receiver does not have a requirement to react to the fiber cut, and can accordingly continue without any detection- or switching delay (i.e., the latency of processing the redundancy as set forth above may be incorporated as a non-mission-critical system design variable).

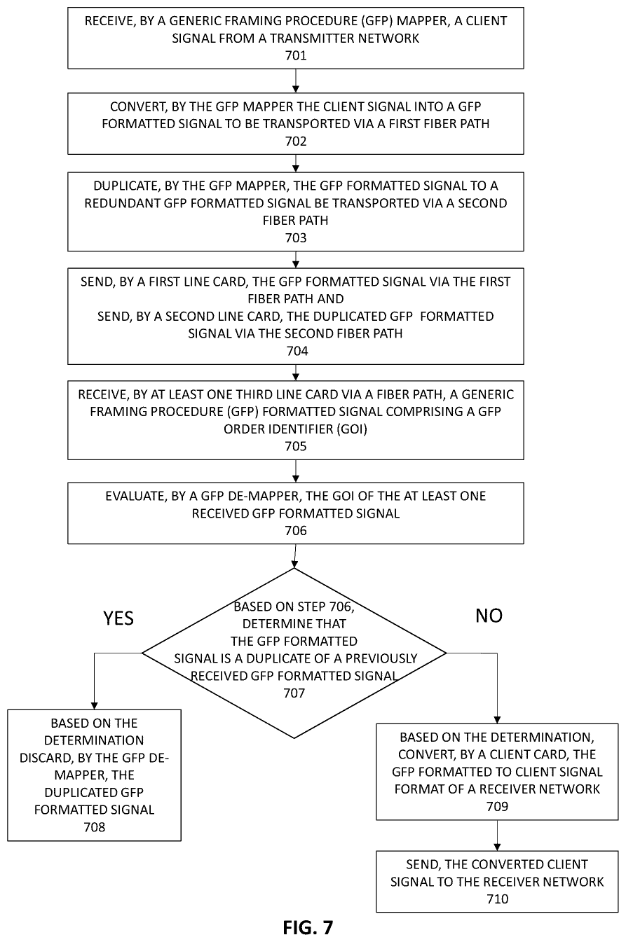

FIG. 7 illustrates a method for implementing an optimization of switching time between fiber paths in OTN's according to an embodiment.

Referring to FIG. 7, in step 701, a system (which may include a transmitter and receiver such as the ones described with reference to FIGS. 4-6 above) may receive, by a Generic Framing Procedure (GFP) mapper, a client signal from a transmitter network.

In step 702, the system may convert, by the GFP mapper, the client signal into a GFP formatted signal to be transported via a first fiber path.

In step 703, the system may duplicate, by the GFP mapper, the GFP formatted signal to a redundant GFP formatted signal to be transported via a second fiber path.

In step 704, the system may add, by the GFP mapper, a GFP Order Identifier (GOI) to the converted client signal for the first path and a GFP Order Identifier (GOI) to the duplicated client signal for the second fiber path.

In step 705, the system may send, by a first line card, the GFP formatted signal via the first fiber path and, by a second line card, sends the duplicated GFP formatted signal via the second fiber path.

In step 706, the system may receive, by at least one third line card via a fiber path, a Generic Framing Procedure (GFP) formatted signal comprising a GFP Order Identifier (GOI).

In step 706, the system may evaluate, by a GFP de-mapper, the GOI of the at least one received GFP formatted signal.

In step 707, the system, based on the evaluation of the at least one GOI, may determine, by the GFP de-mapper, whether the GFP formatted signal is a duplicate of a previously received GFP formatted signal or not.

In step 708, based on the determination that a GFP formatted signal is a duplicate of a previously received GFP formatted signal (Yes in step 707), the system may discard, by the GFP de-mapper, the duplicated GFP formatted signal.

In step 709, the system, based on the determination that a GFP formatted signal is not a duplicate of a previously received GFP formatted signal (No in step 707) may convert, by a client card, the GFP formatted to client signal format of a receiver network.

In step 710, the system may send, by the client card, the converted client signal to the receiver network.

Based on the above described embodiments with reference to FIG. 7, the method for implementing an optimization of switching time between fiber paths in OTN's may allow for a proactive mechanism of constantly providing a duplicate of a GFP formatted client signal to be transported over a separate fiber path (a separate fiber path which enables a seamless switching (transition) in a constant (predetermined non-mission-critical) time between tens or hundreds of nanoseconds). This predetermined (non-mission-critical) time facilitates the requirements for the resilient operation of ultra-low latency client network, thereby allowing for the processing of next-generation time-critical services (e.g., (open) RAN-based IoT networks, autonomous driving, etc.).

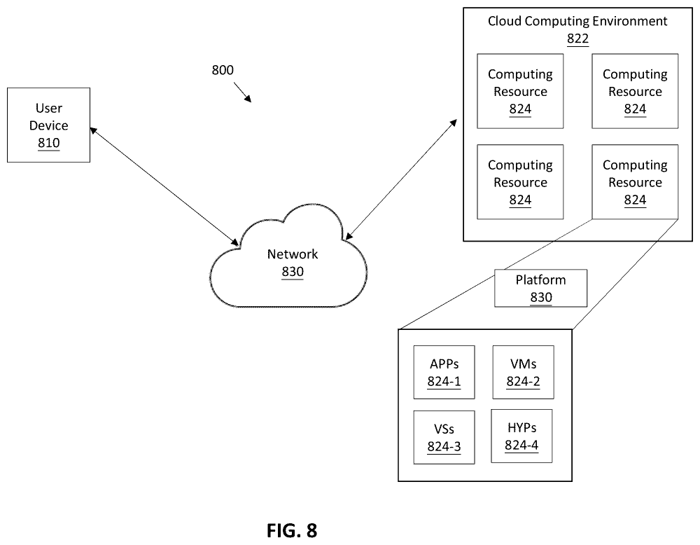

FIG. 8 is a diagram of an example environment 800 in which systems and/or methods, described herein, may be implemented. As shown in FIG. 8, environment 800 may include a user device 810, a platform 820, and a network 830. Devices of environment 800 may interconnect via wired connections, wireless connections, or a combination of wired and wireless connections. In embodiments, any of the functions and operations described with reference to FIGS. 1A, 1B, 2A and 2B above may be performed by any combination of elements illustrated in FIG. 8.

User device 810 includes one or more devices capable of receiving, generating, storing, processing, and/or providing information associated with platform 820. For example, user device 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 810 may receive information from and/or transmit information to platform 820.

Platform 820 includes one or more devices capable of receiving, generating, storing, processing, and/or providing information. In some implementations, platform 820 may include a cloud server or a group of cloud servers. In some implementations, platform 820 may be designed to be modular such that certain software components may be swapped in or out depending on a particular need. As such, platform 820 may be easily and/or quickly reconfigured for different uses.

In some implementations, as shown, platform 820 may be hosted in cloud computing environment 822. Notably, while implementations described herein describe platform 820 as being hosted in cloud computing environment 822, in some implementations, platform 820 may not be cloud-based (i.e., may be implemented outside of a cloud computing environment) or may be partially cloud-based.

Cloud computing environment 822 includes an environment that hosts platform 820. Cloud computing environment 822 may provide computation, software, data access, storage, etc., services that do not require end-user (e.g., user device 810) knowledge of a physical location and configuration of system(s) and/or device(s) that hosts platform 820. As shown, cloud computing environment 822 may include a group of computing resources 824 (referred to collectively as “computing resources 824” and individually as “computing resource 824”).

Computing resource 824 includes one or more personal computers, a cluster of computing devices, workstation computers, server devices, or other types of computation and/or communication devices. In some implementations, computing resource 824 may host platform 820. The cloud resources may include compute instances executing in computing resource 824, storage devices provided in computing resource 824, data transfer devices provided by computing resource 824, etc. In some implementations, computing resource 824 may communicate with other computing resources 824 via wired connections, wireless connections, or a combination of wired and wireless connections.

As further shown in FIG. 8, computing resource 824 includes a group of cloud resources, such as one or more applications (“APPs”) 824-1, one or more virtual machines (“VMs”) 824-2, virtualized storage (“VSs”) 824-3, one or more hypervisors (“HYPs”) 824-4, or the like.

Application 824-1 includes one or more software applications that may be provided to or accessed by user device 810. Application 824-1 may eliminate the need to install and execute the software applications on user device 810. For example, application 824-1 may include software associated with platform 820 and/or any other software capable of being provided via cloud computing environment 822. In some implementations, one application 824-1 may send/receive information to/from one or more other applications 824-1, via virtual machine 824-2.

Virtual machine 824-2 includes a software implementation of a machine (e.g., a computer) that executes programs like a physical machine. Virtual machine 824-2 may be either a system virtual machine or a process virtual machine, depending upon use and degree of correspondence to any real machine by virtual machine 824-2. A system virtual machine may provide a complete system platform that supports execution of a complete operating system (“OS”).

A process virtual machine may execute a single program, and may support a single process. In some implementations, virtual machine 824-2 may execute on behalf of a user (e.g., user device 810), and may manage infrastructure of cloud computing environment 822, such as data management, synchronization, or long-duration data transfers.

Virtualized storage 824-3 includes one or more storage systems and/or one or more devices that use virtualization techniques within the storage systems or devices of computing resource 824. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 824-4 may provide hardware virtualization techniques that allow multiple operating systems (e.g., “guest operating systems”) to execute concurrently on a host computer, such as computing resource 824. Hypervisor 824-4 may present a virtual operating platform to the guest operating systems and may manage the execution of the guest operating systems. Multiple instances of a variety of operating systems may share virtualized hardware resources.

Network 830 includes one or more wired and/or wireless networks. For example, network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of environment 800 may perform one or more functions described as being performed by another set of devices of environment 800.

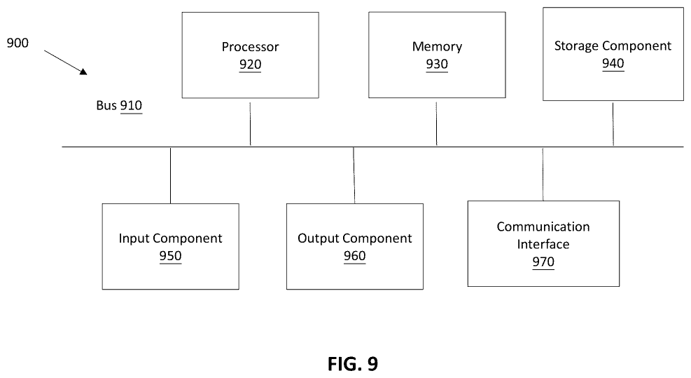

FIG. 9 illustrates an embodiment of a device 900. As shown in FIG. 9, the device 900 processor 910, a memory 920, a storage component 930, an input component 940, an output component 950, a communication interface 960, and a bus 970.

The processor 910, as used herein, means any type of computational circuit that may comprise hardware elements and software elements. The processor 910 may be embodied as a multi-core processor, a single core processor, or a combination of one or more multi-core processors and/or one or more single core processors, a distributed processing system, or the like. The processor 910 may be a Central Processing Unit (CPU) a graphics processing unit (GPU), an accelerated processing unit (APU), an application-specific integrated circuit (ASIC), or another type of processing component.

Memory 920 includes a non-transitory computer readable medium. Memory 920 includes a random-access memory (RAM), a read only memory (ROM), and/or another type of dynamic or static storage device (e.g., a flash memory, a magnetic memory, and/or an optical memory) that stores information and/or instructions for use by processor 910. The memory 920 comprises machine-readable instructions which are executable by the processor 910. These machine-readable instructions when executed by the processor 910 cause the processor 910 to perform one or more method steps of an embodiment described above.

Storage component 930 stores information and/or software related to the operation and use of the device 900. For example, storage component 930 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 940 is configured to receive information, such as user input. For example, the input component 940 may include, but not be limited to, a touch screen display, a keyboard, a keypad, a mouse, a button, a switch, and/or a microphone. Additionally, or alternatively, the input component 940 may include a sensor for sensing information (e.g., a global positioning system (GPS), an accelerometer, a gyroscope, and/or an actuator).

Output component 950 is configured to provide output information from the device 900. For example, the output component 950 may be, but not limited to, a display, a speaker, instructions to an external device, and/or one or more light-emitting diodes (LEDs).

Communication interface 960 is an interface that provides a communication connection to other devices, such as external devices and internal devices. The connection by the communication interface 960 can be a wired connection, a wireless connection, or a combination of wired and wireless connections, and can be a direct connection or an indirect connection via a communication network that exists between the device 900 and other devices. In other words, the standard of the communication interface 960 is not limited.

The bus 970 acts as an interconnect between the processor 910, the memory 920, the storage component 930, the input component 940, the output component 950, and the communication interface 960 of the device 900. The bus 970 may include a wired interconnection or a wireless interconnection.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900. Further, one or more method steps described in any of the embodiments may be performed utilizing a plurality of devices 900 in communication with one another.

In embodiments, any one of the operations or processes of FIGS. 1A, 1B, 2A and 2B may be implemented by or using any one of the elements illustrated in FIGS. 8 and 9. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Various further respective aspects and features of embodiments of the present disclosure may be defined by the following items:
Item [1]: A method including: receiving, by a Generic Framing Procedure (GFP) mapper, a client signal from a transmitter network; converting, by the GFP mapper the client signal into a GFP formatted signal to be transported via a first fiber path; duplicating, by the GFP mapper, the GFP formatted signal to a redundant GFP formatted signal to be transported via a second fiber path; adding, by the GFP mapper, a GFP Order Identifier (GOI) to the converted client signal for the first path and a GFP Order Identifier (GOI) to the duplicated client signal for the second fiber path; sending, by a first line card, the GFP formatted signal via the first fiber path; and sending, by a second line card, the duplicated GFP formatted signal via the second fiber path.
Item [2]: The method according to Item [1], further including: receiving, by at least one line card via a fiber path, the GFP formatted signal comprising the GOI; and evaluating, by a GFP de-mapper, the GOI of the at least one received GFP formatted signal.
Item [3]: The method according to Item [2], further including: based on the evaluation of the at least one GOI, determining, by the GFP de-mapper, that the GFP formatted signal is a duplicate of a previously received GFP formatted signal; and based on the determination, discarding, by the GFP de-mapper, the duplicated GFP formatted signal.
Item [4]: The method according to Item [3], wherein the evaluating the GOI of the at least one received GFP formatted signal further includes: based on the evaluation of the at least one GOI, determining, by the GFP de-mapper, that the GFP formatted signal received via the fiber path is not a duplicate of a previously received GFP formatted signal; based on the determination, converting, by a client card, the GFP formatted signal to a client signal format of a receiver network; and sending, by the client card, the converted client signal to the receiver network.
Item [5]: The method according to any one of Items [3]-[4], wherein the determining that the GFP formatted signal is a duplicate of a previously received GFP formatted signal further includes: based on the determination, converting, by a client card, the previously received GFP formatted signal to a client signal format of a receiver network; and sending, by the client card, the converted client signal to the receiver network.
Item [6]: The method according to any one of Items [1]-[5], wherein the GOI is implemented as at least one bit in a GPF frame header field.
Item [7]: The method according to any one of Items [4]-[5], wherein the determination that the GFP formatted signal received over the at least one fiber path is not a duplicate of a previously received GFP formatted signal is made between tens or hundreds of nanoseconds.
Item [8]: A system including a transmitter and a receiver, wherein the transmitter is configured to: receive a client signal from a transmitter network, convert the client signal into a GFP formatted signal to be transported via a first fiber path, duplicate the GFP formatted signal to a redundant GFP formatted signal to be transported via a second fiber path, add a GFP Order Identifier (GOI) to the converted client signal for the first path and a GFP Order Identifier (GOI) to the duplicated client signal for the second fiber path, send the GFP formatted signal via the first fiber path, and send the duplicated GFP formatted signal via the second fiber path to the receiver.
Item [9]: The system according to Item [8], wherein the receiver is configured to: receive the GFP formatted signal comprising the GOI; and evaluate the GOI of the at least one received GFP formatted signal.
Item [10]: The system according to Item [9]: wherein the receiver is further configured to: based on the evaluation of the at least one GOI, determine that the GFP formatted signal is a duplicate of a previously received GFP formatted signal, and based on the determination, discard the duplicated GFP formatted signal.
Item [11]: The system according to Item [10]: wherein the receiver is further configured to: based on the evaluation of the at least one GOI, determine that the GFP formatted signal received via the fiber path is not a duplicate of a previously received GFP formatted signal, based on the determination, convert the GFP formatted signal to a client signal format of a receiver network; and send the converted client signal to the receiver network.
Item [12]: The system according to any one of Items [10]-[11], wherein the receiver is further configured to determine that the GFP formatted signal is a duplicate of a previously received GFP formatted signal by: based on the determination, converting the GFP formatted signal to a client signal format of the receiver network; and sending the converted client signal to the receiver network.
Item [13]: The system according to any one of Items [8]-[12], wherein the transmitter is configured to implement the GOI as at least one bit in a GPF frame header field.
Item [14]: The system according to any one of Items [11]-[12], wherein the receiver is configured to determine that the GFP formatted signal received over the at least one fiber path is not a duplicate of a previously received GFP formatted signal between tens to hundreds of nanoseconds.
Item [15]: At least one non-transitory computer-readable recording medium having recorded thereon instructions executable to implement a method including: receiving, by a Generic Framing Procedure (GFP) mapper, a client signal from a transmitter network; converting, by the GFP mapper the client signal into a GFP formatted signal to be transported via a first fiber path; duplicating, by the GFP mapper, the GFP formatted signal to a redundant GFP formatted signal to be transported via a second fiber path; adding, by the GFP mapper, a GFP Order Identifier (GOI) to the converted client signal for the first path and a GFP Order Identifier (GOI) to the duplicated client signal for the second fiber path; sending, by a first line card, the GFP formatted signal via the first fiber path; and sending, by a second line card, the duplicated GFP formatted signal via the second fiber path.
Item [16]: The at least one non-transitory computer-readable recording medium according to Item [15], wherein the method further includes: receiving, by at least one line card via a fiber path, a Generic Framing Procedure (GFP) formatted signal comprising a GFP Order Identifier (GOI); and evaluating, by a GFP de-mapper, the GOI of the at least one received GFP formatted signal.
Item [17]: The at least one non-transitory computer-readable recording medium according to Item [16], wherein the method further includes: based on the evaluation of the at least one GOI, determining, by the GFP de-mapper, that the GFP formatted signal is a duplicate of a previously received GFP formatted signal; and based on the determination, discarding, by the GFP de-mapper, the duplicated GFP formatted signal.
Item [18]: The at least one non-transitory computer-readable recording medium according to any one of Items [16]-[17], wherein the evaluating the GOI of the at least one received GFP formatted signal further includes: based on the evaluation of the at least one GOI, determining, by the GFP de-mapper, that the GFP formatted signal received via the fiber path is not a duplicate of a previously received GFP formatted signal; based on the determination, converting, by a client card, the GFP formatted signal to a client signal format of a receiver network; and sending, by the client card, the converted client signal to the receiver network.
Item [19]: The at least one non-transitory computer-readable recording medium according to any one of Items [15]-[18], wherein the GOI is implemented as at least one bit in a GPF frame header field.
Item [20]: The at least one non-transitory computer-readable recording medium according to Item [18], wherein the determination that the GFP formatted signal received over the at least one fiber path is not a duplicate of a previously received GFP formatted signal is made between tens or hundreds of nanoseconds.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method comprising:
receiving, by a Generic Framing Procedure (GFP) mapper, a client signal from a transmitter network;
converting, by the GFP mapper the client signal into a GFP formatted signal to be transported via a first fiber path;
duplicating, by the GFP mapper, the GFP formatted signal to a redundant GFP formatted signal to be transported via a second fiber path;
adding, by the GFP mapper, a GFP Order Identifier (GOI) to the converted client signal for the first path and a GFP Order Identifier (GOI) to the duplicated client signal for the second fiber path;
sending, by a first line card, the GFP formatted signal via the first fiber path; and
sending, by a second line card, the duplicated GFP formatted signal via the second fiber path.

2. The method as claimed in claim 1, further comprising:
receiving, by at least one line card via a fiber path, the GFP formatted signal comprising the GOI;
evaluating, by a GFP de-mapper, the GOI of the at least one received GFP formatted signal.

3. The method as claimed in claim 2, further comprising:
based on the evaluation of the at least one GOI, determining, by the GFP de-mapper, that the GFP formatted signal is a duplicate of a previously received GFP formatted signal; and
based on the determination, discarding, by the GFP de-mapper, the duplicated GFP formatted signal.

4. The method as claimed in claim 3, wherein the evaluating the GOI of the at least one received GFP formatted signal further comprises:
based on the evaluation of the at least one GOI, determining, by the GFP de-mapper, that the GFP formatted signal received via the fiber path is not a duplicate of a previously received GFP formatted signal;
based on the determination, converting, by a client card, the GFP formatted signal to a client signal format of a receiver network; and
sending, by the client card, the converted client signal to the receiver network.

5. The method as claimed in claim 3, wherein the determining that the GFP formatted signal is a duplicate of a previously received GFP formatted signal further comprises:
based on the determination, converting, by a client card, the previously received GFP formatted signal to a client signal format of a receiver network; and
sending, by the client card, the converted client signal to the receiver network.

6. The method as claimed in claim 1, wherein the GOI is implemented as at least one bit in a GPF frame header field.

7. The method as claimed in claim 4, wherein the determination that the GFP formatted signal received over the at least one fiber path is not a duplicate of a previously received GFP formatted signal is made between tens or hundreds of nanoseconds.

8. A system comprising a transmitter and a receiver, wherein the transmitter is configured to:
receive a client signal from a transmitter network,
convert the client signal into a GFP formatted signal to be transported via a first fiber path,
duplicate the GFP formatted signal to a redundant GFP formatted signal to be transported via a second fiber path,
add a GFP Order Identifier (GOI) to the converted client signal for the first path and a GFP Order Identifier (GOI) to the duplicated client signal for the second fiber path,
send the GFP formatted signal via the first fiber path, and
send the duplicated GFP formatted signal via the second fiber path to the receiver.

9. The system as claimed in claim 8, wherein the receiver is configured to:
receive the GFP formatted signal comprising the GOI; and
evaluate the GOI of the at least one received GFP formatted signal.

10. The system as claimed in claim 9, wherein the receiver is further configured to:
based on the evaluation of the at least one GOI, determine that the GFP formatted signal is a duplicate of a previously received GFP formatted signal, and
based on the determination, discard the duplicated GFP formatted signal.

11. The system as claimed in claim 10, wherein the receiver is further configured to:
based on the evaluation of the at least one GOI, determine that the GFP formatted signal received via the fiber path is not a duplicate of a previously received GFP formatted signal,
based on the determination, convert the GFP formatted signal to a client signal format of a receiver network; and
send the converted client signal to the receiver network.

12. The system as claimed in claim 10, wherein the receiver is further configured to determine that the GFP formatted signal is a duplicate of a previously received GFP formatted signal by:
based on the determination, converting the GFP formatted signal to a client signal format of the receiver network; and
sending the converted client signal to the receiver network.

13. The system as claimed in claim 8, wherein the transmitter is configured to implement the GOI as at least one bit in a GPF frame header field.

14. The system as claimed in claim 11, wherein the receiver is configured to determine that the GFP formatted signal received over the at least one fiber path is not a duplicate of a previously received GFP formatted signal between tens to hundreds of nanoseconds.

15. At least one non-transitory computer-readable recording medium having recorded thereon instructions executable to implement a method comprising:
receiving, by a Generic Framing Procedure (GFP) mapper, a client signal from a transmitter network;
converting, by the GFP mapper the client signal into a GFP formatted signal to be transported via a first fiber path;
duplicating, by the GFP mapper, the GFP formatted signal to a redundant GFP formatted signal to be transported via a second fiber path;
adding, by the GFP mapper, a GFP Order Identifier (GOI) to the converted client signal for the first path and a GFP Order Identifier (GOI) to the duplicated client signal for the second fiber path;
sending, by a first line card, the GFP formatted signal via the first fiber path; and
sending, by a second line card, the duplicated GFP formatted signal via the second fiber path.

16. The at least one non-transitory computer-readable recording medium as claimed in claim 15, wherein the method further comprises:
receiving, by at least one line card via a fiber path, a Generic Framing Procedure (GFP)
formatted signal comprising a GFP Order Identifier (GOI); and
evaluating, by a GFP de-mapper, the GOI of the at least one received GFP formatted signal.

17. The at least one non-transitory computer-readable recording medium as claimed in claim 16, wherein the method further comprises:
based on the evaluation of the at least one GOI, determining, by the GFP de-mapper, that the GFP formatted signal is a duplicate of a previously received GFP formatted signal; and
based on the determination, discarding, by the GFP de-mapper, the duplicated GFP formatted signal.

18. The at least one non-transitory computer-readable recording medium as claimed in claim 16, wherein the evaluating the GOI of the at least one received GFP formatted signal further comprises:
based on the evaluation of the at least one GOI, determining, by the GFP de-mapper, that the GFP formatted signal received via the fiber path is not a duplicate of a previously received GFP formatted signal;
based on the determination, converting, by a client card, the GFP formatted signal to a client signal format of a receiver network; and
sending, by the client card, the converted client signal to the receiver network.

19. The at least one non-transitory computer-readable recording medium as claimed in claim 15, wherein the GOI is implemented as at least one bit in a GPF frame header field.

20. The at least one non-transitory computer-readable recording medium as claimed in claim 18, wherein the determination that the GFP formatted signal received over the at least one fiber path is not a duplicate of a previously received GFP formatted signal is made between tens or hundreds of nanoseconds.
